(19) United States
(12) Patent Application Publication
(10) Pub. No.: US 2023/0045071 A1
(43) Pub. Date: Feb. 9, 2023

(54) Physical Non-Fungible Tokens (pNFT) Certificates of Ownership

(71) Applicants: Khaled Ali Kalaldeh, Amman (JO); Tawfiq A. T Sa'deddin, Amman (JO)

(72) Inventors: Khaled Ali Kalaldeh, Amman (JO); Tawfiq A. T Sa'deddin, Amman (JO)

(21) Appl. No.: 17/876,792

(22) Filed: Jul. 29, 2022

Related U.S. Application Data
(60) Provisional application No. 63/228,061, filed on Jul. 31, 2021.

(51) Int. Cl. G06Q 20/38; G06Q 30/00; H04L 9/00

(52) U.S. Cl. CPC G06Q 20/3821; G06Q 30/018; H04L 9/50

(57) ABSTRACT

The present disclosure describes a system, method and computer readable medium for verifying the ownership of an article. In one embodiment, one or more physically unclonable functions may be applied to an article and associated with a non-fungible token in order to create a digital fingerprint. The digital fingerprint may then be stored on a blockchain network and utilized to verify and authenticate the ownership of the article.

### CROSS REFERENCE TO RELATED APPLICATIONS

This application claims priority upon and incorporates by reference herein a provisional patent application entitled “Physical Non-Fungible Tokens (pNFT) Certificates of Ownership,” filed on Jul. 31, 2021, Ser. No. 63/228,061.

### TECHNICAL FIELD

The present disclosure relates, in general, to methods, tools and systems for Non-Fungible Tokens (NFTs) specifically created for representing physical items. The field of which this invention emerges from is a combination of a variety of interdisciplinary sciences and subject matter. Amongst prominence are: NFTs, Optics, Blockchain, Cryptography, Computer Vision, Machine Learning and Image Search Engines.

Non-fungible tokens NFTs started as a type of a digital asset designed to show someone has ownership of a unique virtual item, such as online pictures and videos or even sports trading cards. NFTs are mostly found and stored the same way cryptocurrencies are stored and managed, that is, on a blockchain. Being on a blockchain, ensures that an NFTs are secure and cannot be altered by any way as they would enjoy all the blockchain properties of immutability, decentralization, anonymity and security.

NFT stands for non-fungible token. In economics, a fungible asset is something with units that can be readily interchanged—like money. With money, one can swap a $10 note for two $5 notes and it will have the same value. However, if something is non-fungible, this is impossible—it means it has unique properties so it cannot be interchanged with something else. It could be a house, or a painting such as the Mona Lisa, which is one of a kind. A person can take a photo of the painting or buy a print but there will only ever be the one original painting.

NFTs are “one-of-a-kind” assets in the digital world that can be bought and sold like any other piece of property, but they have no tangible form of their own. The digital tokens can be thought of as certificates of ownership for virtual or physical assets. For example, a digital image having an NFT is essentially tokenizing that “fact” that it's “one of a kind” or rare, even if it was copied a million times, only one person can own the “claim” of ownership of its rarity and sell it later to someone else.

Recently Non-Fungible Tokens, have spurred a frenzy around the world of internet with the concepts and implications it carries; trustless or decentralized certificates of ownership for digital assets have become mainstream; such NIT tokens serve as certificates of ownership associated with, say, a digital image where the NFT becomes the asset itself and is said to be much more valuable than the real underlying asset it beholds its ownership certificate for!

To appreciate why NFTs for virtual and digital assets are more common and successful than their physical counterparts, the NFT design itself will be first discussed. NFTs isolate and represent the rarity aspect of any asset as a separate token entity away from the asset, so there is no need for a robust connection to exist between an NFT and one specific digital asset of say like an image to maintain that rarity, it only suffices for that NFT to indicate or point to that digital asset in its token metadata that it belongs to that digital asset, whereas the digital asset itself could be stored as an image somewhere and anyone can copy that image but not anyone can claim its rarity token in the same manner, because all of these identical image copies have only one NFT which as will be seen is not the case of many multiple physical assets as each and every asset would need its own unique and different NFT.

Again as NFTs are concerned with tokenizing the rarity of some digital asset as a unique token and not the digital asset itself, the digital asset is free to exist and be in abundance; i.e. the NFT token is non-fungible but the digital asset is not. On contrary to digital assets, after creating an NFT for a physical asset, this particular asset cannot afterwards, like the digital asset case, exist in abundance even if there are many identical items of it out there, because by definition only one person or entity can own that particular physical asset with its NFT once at a time. Due to their physical nature, these asset-types are not ubiquitous like digital assets and images, and therefore, rarity for a physical asset-type NFT cannot exist in isolation away from its physical asset, and for that reason, there has to exist not only a unique NFT token to that asset, but instead the asset itself must be unique and non-fungible as well. To achieve that rarity in both worlds the physical and the cyber, both the physical asset and its NFT token must somehow become connected in a unique unbreakable bond as well and where one cannot exist without the other.

As buyers do eventually need to own the physical asset itself and not only its rarity claim of ownership i.e. NFT, maintaining a bond or a connection of a physical asset with its NFT token is needed to tokenize physical items rarity, and as this connection itself becomes verifiable; buyers of physical NFTs can without doubt verify that this NFT belongs to that particular physical asset at hand. So the following question arises: how to create a secure, permanent, trusted and verifiable connection between the two, the physical asset and its NFT?

Simply to issue or “mint” a digital certificate of ownership i.e.: NFT for an underlying physical asset, the issuer or creator has to be able to make sure that this specific physical asset has its issued NFT attached to it at all times and points to that same exact physical asset and not a similar or identical one. This is a daunting job that requires meticulous work and supply chain management beyond individuals' capacities; albeit some methods have been introduced, nearly all of them are not counterfeit-proof as they depend on tagging the physical assets with the likes of QR codes, RFIDs, NFCs and other forms of physical identifiers that are all prone to vulnerabilities due to the ease of which they can be ceased, cloned and detached from their physical counterparts and, therefore, cannot be as pervasive as needed as they do not become an integral and perpetual part of the physical asset in question.

It's worth to note, that as a result of the works of this invention; a new breed and class of NFTs are derived; specifically, by pairing an intrinsic unique physical asset identifier with properties that will be detailed later on; such unique identifier when coupled to the standard NFT token existing on a certain blockchain creates a new category and a novel type of NFTs. This new category denoted as pNFT; where p stands for the word physical which represents the physical asset's unique identifier called herein the “fingerprint”. pNFTs, by definition, are said to be made up of two entities; the NFT token and a hash fingerprint the (p). Both entities need to be minted “created” both in the digital and the physical worlds then combined in one token, the pNFT.

This invention provides a novel and useful realizable method, apparatus and algorithm in different system configurations to achieve the needed inseparability of physical identifiers (fingerprint p) from their physical assets counterparts. Whereby, when creating an NFT for a physical asset, both the asset and its NFT are ever linked via the new physical identifier; in this invention these physical identifiers cannot be detachable or reproduced from their physical assets by any feasible practical means using cost-effective technology.

Furthermore, as this invention depicts the creation of a robust unbreakable connection between the physical asset and its digital NFT token, such system has been reduced to practice and proved to function as described in this application. Although, some of the methods incorporated within this application and of the prescribed system might have been used in different configurations, contexts or setups in the prior art to counteract counterfeiting or prove authenticity of a certain material; this invention is primarily concerned with issuing rarity and Certificates of Ownership of physical assets regardless wither these assets themselves are of authentic origin or not.

### GENERAL BACKGROUND

The advent of NFTs created a niche market of collectors of digital art and digital assets and creators of those assets; with both sides representing demand and supply, the market of NFTs rapidly grew where digital certificates of ownership are the commodity not the assets themselves; but one area where NFTs have not shined as they did for digital collections and therein assets, was physical assets.

This invention relates to the broader inclusion of the larger population of physical assets' owners to enable them to actively participate in the nascent NFT economy. With this invention and its ubiquitous utility, those previously “isolated”, can now contribute with transacting billions of physical assets certificates that are globally distributed as they become native issuers and collectors of NFTs on the blockchain with the ease and simplicity of using a messaging application on a smartphone.

The majority of the applications envisioned for pNFTs and the utility it provides are yet to be seen as innovations that promise to revolutionize the commerce of physical assets. This invention paves the way for a new dawn of physical assets' commerce by providing the tools and platform to allow anyone to create, transmit and exchange their physical assets all around the world with a digital first approach, physical entities can now be treated the same as one would download today a piece of software over the internet!

Allowing a new form for commerce of physical assets signals a new era where assets appear as if they are teleported and where physical assets are said to be delivered once sold or purchased! Only now this became possible because physical Certificates of Ownership (pNFTs) are instantaneously delivered to the buyer. At the time of writing this application, Buy Now Pay Later schemes are common in the finance world, likewise, Own Now Deliver Later schemes will revolutionize e-commerce as we know it today. i.e. Own Now refers to owning the pNFT in a sense that it's now the new trusted shadow asset representative of the real asset where the pNFT token is known to be inseparable from the physical asset it represents.

With the latter future visualization becoming a reality, one can now imagine how reselling the same pNFT'ed physical asset multiple times becomes readily available option without the limiting logistics and lead times of shipping physical assets repeatedly each time, but instead shipping happens only to the final destination and last owner in the chain.

Also, the trust element between a buyer and a seller can now be established by holding payment amounts in custody at a marketplace at which the transaction is happening, and remains at hold until the buyer physically verifies the pNFT of the physical item just bought and sent by the seller to be matching exactly the one in the designated pNFT blockchain or database, after such verification happens, payment will automatically be released via a smart contract mechanism to the seller via the same marketplace.

During transactions of the “Own Now Deliver Later” model explained earlier, a royalty scheme might be deployed to allow and incentivize creators of physical artwork and other items to generate income while the pNFT is being transacted to different owners during its life time, such business model might be programmed in the so called smart contract governing the pNFT on blockchain to allow certain percentage say 10% of the pNFT token sale always to go to the original minter or creator of the physical token.

It has been established in the classical world of NFTs the little significance and emphasis placed to the ownership of digital assets themselves as opposed to possessing the claim of their ownership; that's of course inconsistent with the need of real ownership of physical goods required to take place during the exchange of physical goods i.e.: commerce. Being the backbone of today's economy, commerce, on contrary to today's NFTs concepts and architecture, is all about the transfer of asset ownership itself from one person or entity to another.

However, for NFTs to work in the physical assets world, the accompanying certificate of ownership in the physical world still lack the scalable infrastructure and enabling technology, which this invention attempts to provide, to further spur new business models where the claim of ownership not the possession of the physical asset itself becomes where the most of value would resides and concentrates just like the NFT in the world of digital assets, it turns out that not only that is possible but it also brings tremendous value to the world of commerce of physical assets.

Despite the shift of value NFTs instills in value chains towards owning a tokenized Claim of some nature like rarity instead of real true ownership and possession, physical makers around the world are rushing to incorporate NFTs to accompany their physical products, for example, issuing a limited perfume edition via NFT, or a limited luxury watch set or a pair of brand sunglasses all would require NFTs. Moreover, these brands and products are still faced with the same dilemma of separation between physical items and their NF's that even if created in some form or another, it remains a weak, fragile and untrusted connection, that often, leaving this connection exposed to fraudulent attempts as its susceptible to forgery. With the absence of pNFT and before this invention existed, NFTs used for tokenizing rarity and creating limited editions for physical items still lacked a practical, scalable, discernable, unique and secure format to connect, merge and consolidated physical items with their NFTs.

NFTs are gradually transforming the world of physical assets away from the demand for proof of asset issuer (authenticity) to both demands of proof of user (legacy) and proof of unique creation (rarity).

Transforming ownerships away from authenticity that focuses on proof of asset issuer, towards proof of legacy and rarity tokenization are slowly gaining grounds and replacing authenticity as a metric of genuine physical goods transactions. Here, pNFTs, can be seen unlocking billions of dollars in commerce and daily transactions as physical assets can seamlessly take part in the new trustless NFT “smart contract based” economy leveraging the power of blockchain technology and the new dawn of tokenized asset uniqueness and/or rarity.

The paradigm shifts this invention predicates describes going from stressing the authenticity of goods towards the ownership centricity where anybody and everybody can become a creator or issuer and where claims of ownership become key to value the goods in transactions not only their authenticity. To comprehend that shift, we recall the 2020 pandemic; COVID-19 created an unmistakable paradigm shifts that were unforeseeable and incomprehensible at the time; after COVID, work and study from home proved that these life axioms are far more than activities that take place only at and are permitted by the existence of some physical place.

That belief held for centuries; that work and study need a physical space to occur, is now no longer true or even viable! Likewise, in physical products exchange, withstanding the fact that physical products would still be seen as the prime beholder and custodian asset could no longer be the case! With pNFTs physical items and products will have an intrinsic value or dimension added to the overall asset characteristics, which will transcend space and matter because now these assets can be properly represented by the likes of pNFTs where every creation has a brand-like attribute attached to it and where each brand of asset promises and exhibits (status, rarity, pride, ego, legacy, utility) in the new world of NFTs.

Furthermore, this application covers the scope of putting the invention to use in a wide, practical and scalable forms of consumption and utility. In order to do that, the invention, depicts various form factors of apparatuses for a user to create, read and verify a pNFT, amongst most interesting are those only utilizing one's smartphone; as such, a smartphone minting and/or verifying physical assets' pNFTs makes any physical asset universally available to be sent over to any other recipient anywhere on the globe as long the receiving end is equipped with a smartphone and the required software app.

### SUMMARY OF THE INVENTION

In general, this invention relates to; Firstly, issuing Certificates of Ownership that are said to have a new inseparable intrinsic identity “fingerprint” derived from and permanently attached to physical assets as such these are secure, impregnable and perpetual as its NFT counterpart on the blockchain, and then Secondly, preserving this intrinsic identity or “fingerprint” as an encrypted metadata stored and registered in the same NFT certificate or smart contract of that physical asset. Thirdly, devising a method of verification that the stored fingerprints minted, i.e.: that were created in the first place for physical assets with their correspondent NFTs are verified to be indeed matching and belonging to the same physical assets these fingerprints are now being read from.

These “fingerprints” associated and derived or “minted” from the physical assets at the time the creator created the NFT are described elaborately in this application and they would serve and stand as ideal intrinsic identifiers of physical items because (i) they exhibit a very high entropy˜900 bits+ of uniqueness, (ii) form visual ornaments or patterns discernable by the use of computers (iii) Highly tolerant and work as permanent identifiers due to their resilience to change and immutability with daily use as they don't fade away with time for they are naturally embedded within virtually any physical asset's surface.

Furthermore, the process of having pNFTs with the capacity and ability to encompass all of physical assets envisaged in existence, stems from the fact that all physical assets inherently possess a fingerprint-like material property that can be examined under a sufficiently adequate magnifying lens which functions as a microscopic apparatus, such device could be in the form of multiple magnifying consolidated lenses or as a standalone smart vision system with processor capabilities running computer vision software algorithms for discerning desired features and generating fingerprints, whether further encoded or encrypted, for later processing and storage inside an NFT token architecture residing on a computer database, cloud or a blockchain.

With a 100-800× magnification lens apparatus, an observer sees a physical asset's material details under examination as embodied interweaved constellation of random troughs, valleys and hills topography or a random pattern of highly casual painting as if drawn by an abstract artist painter. Due to the random microscopic 3D composition and makeup of the surface of an examined physical object Ornament, these microscopic structural details are inherently unique and cannot be reproduced by existing technology on a microscopic level, these are commonly referred in the literature to as Physical Unclonable Functions or PUFs.

This application is believed to be the first account of its type to link visual PUFs having unique physical asset fingerprints with NFTs for the purpose of issuing an inseparable NFT certificate of ownership from its physical item tokenizing rarity and limited and special edition product-types. Other accounts in the art have utilized PUFs solely for the purpose of genuine authentication of a physical item to combat forgery, therefore, whether a user wishes to utilize pNFTs for purposes of authenticity verification remains not the focus or scope of this application at hand nor does it represent the inventive steps made in its creation.

It is essential to reiterate that blockchain based Certificates of Ownership or NFTs are a novel concept by themselves, and this what is believed to gives this application the non-obviousness of using PUFs to create NFTs from all existing prior art and by those skilled in the art who for years dwelled into and pondered primarily about how to utilize the wide field of PUFs exclusively for authenticity applications and combating forgery; whereas pNFTs central idea, by definition, revolves around ownership verification and not authenticity verification i.e. pNFTs answer the following question: Do I get the same thing that I purchased? Is there a transactional bullet proof certificate of ownership to record and state that?

Furthermore, these fingerprints are structurally embedded in the objects themselves hence they are “hardcoded” in their materials and are known to be resilient features that cannot be easily abolished by everyday usage or certain amounts of abrasion, soaking, heat treatment or normal friction, these PUFs can guarantee that whenever the intrinsic material “fingerprints” are properly probed with the right apparatus, then our algorithms were shown to generate a persistent codified and uniquely encoded digital string of code—or a Hash for each individual “fingerprint”.

These Hashes can then be used as the basis of verifying that the same physical object scanned at hand is indeed the same one bearing the fingerprint to the one stored in a certain pNFT blockchain. This process of verification is fundamental to prospective users of pNFT who can always verify that they behold the right and true pNFT certificate for a physical asset they've just purchased and vice versa. This application discusses in detail three main processes of fingerprint generation “minting”, reading and verification.

### ALL FIGURES LIST

FIG. 1: Physical Object Showing a microscopic visual ornament embedded on its surface

FIG. 2: Physical Object signature identities derived from visual ornament encoding

FIG. 3: Physical Object signature storage on a blockchain ledger

FIG. 4: Process of image hash creation

FIG. 5: Comparison of real image size vs extracted features vs hashed image

FIG. 6: Conceptual design of a pen like reading device or “Mining Rig”

FIG. 7: Illustration of an embedded magnifying utility on physical item

FIG. 8: Components of a magnifying utility

FIG. 9: Attachment of a magnifying utility onto a smart phone camera

FIG. 10: Integration of magnifying utility into a smart phone camera embodiment

FIG. 11: Mounting adapters for magnifying utility attachment to physical items and smartphones cameras

FIG. 12: Depth of Field, focal and illumination transparent phone camera adapter for situating magnifying utility

FIG. 13: Lighting mechanism on washer mounting adapter for magnifying utility

FIG. 14: Lighting mechanism with On/Off button+Battery

FIG. 15: PIN Code reading stencil for sequence reading against counterfeiting and forgery

FIG. 16: General Blockchain Architecture

FIG. 17: Hash Value Inheritance in Blockchain

FIG. 18: Combining of NFT and Art in various storage configurations

FIG. 19: NFT and IPFS Networks Use of CID Hashes for Metadata

FIG. 20: Anatomy of a Fingerprint in Place of CID Hashes inside an IPFS

FIG. 21: Using Computer Vision to Tokenize Assets on the same NFT Token

FIG. 22: pNFT: The Big Picture

FIG. 23: CIDs, Artworks, Assets and NFT Search Engines

FIG. 24: Luxury products with built-in magnification utility

FIG. 25: Toys and Gimmicks with built-in magnification utility

FIG. 26: Sample Microscopic PUFs or Visual Ornaments of Some Real Physical Items

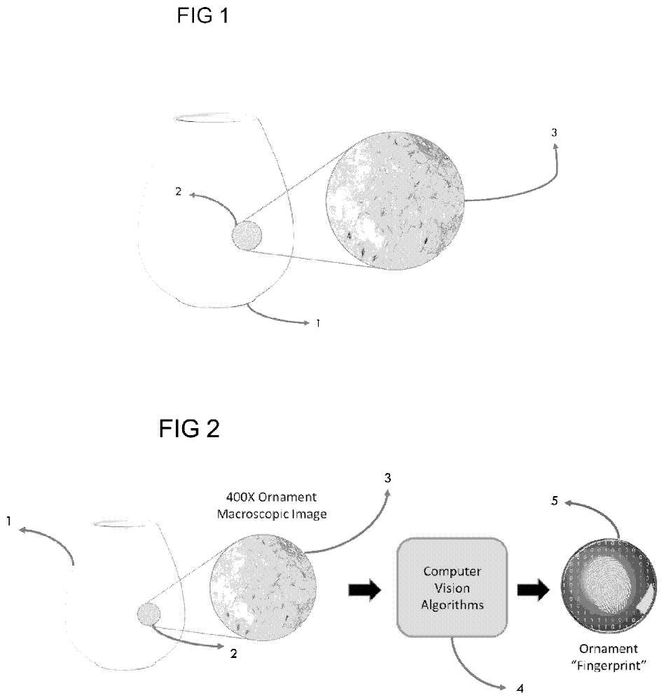

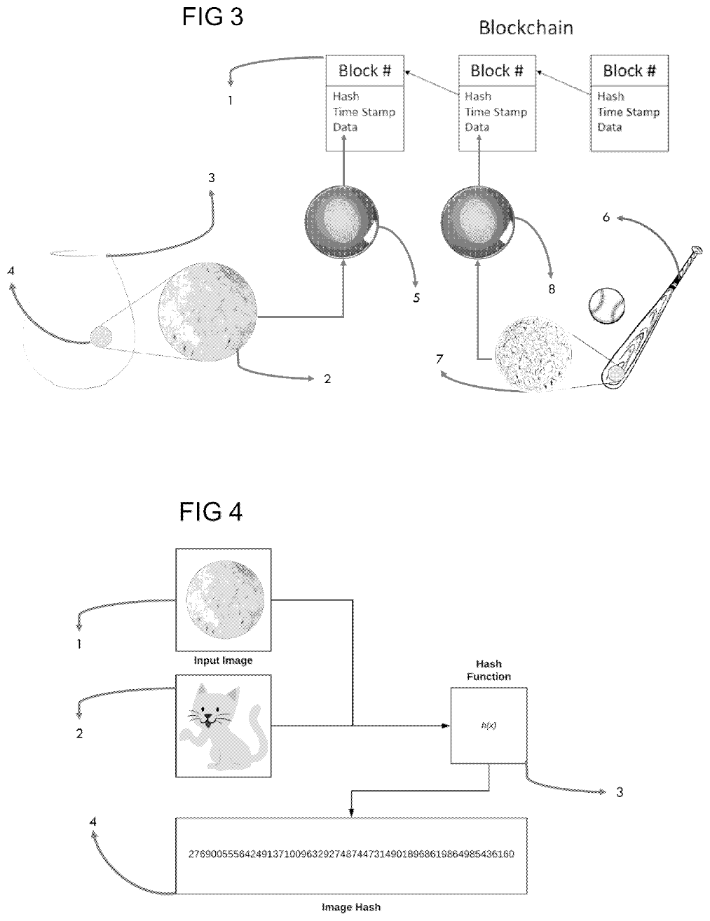

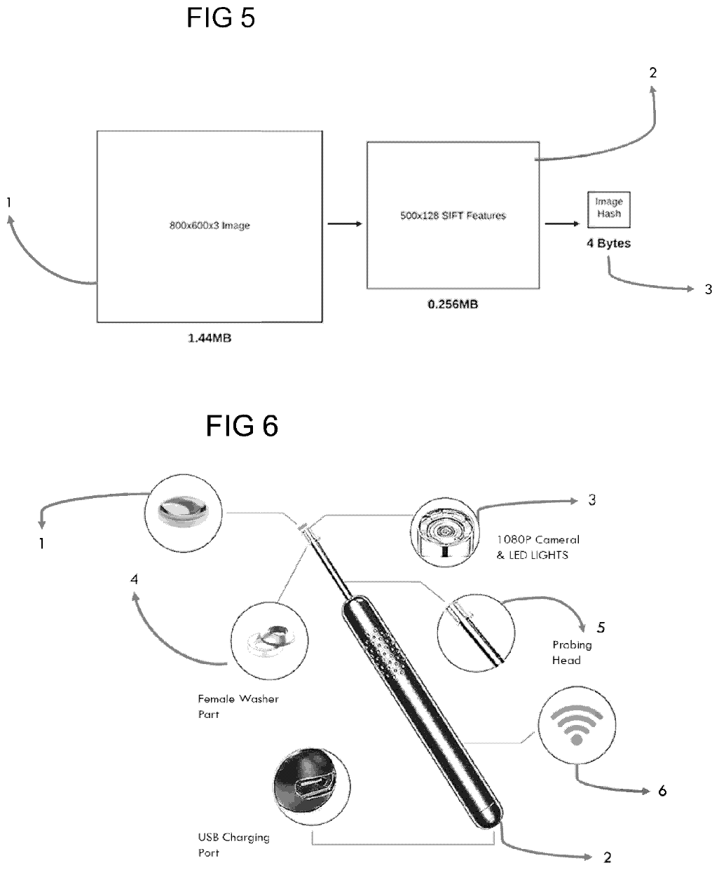

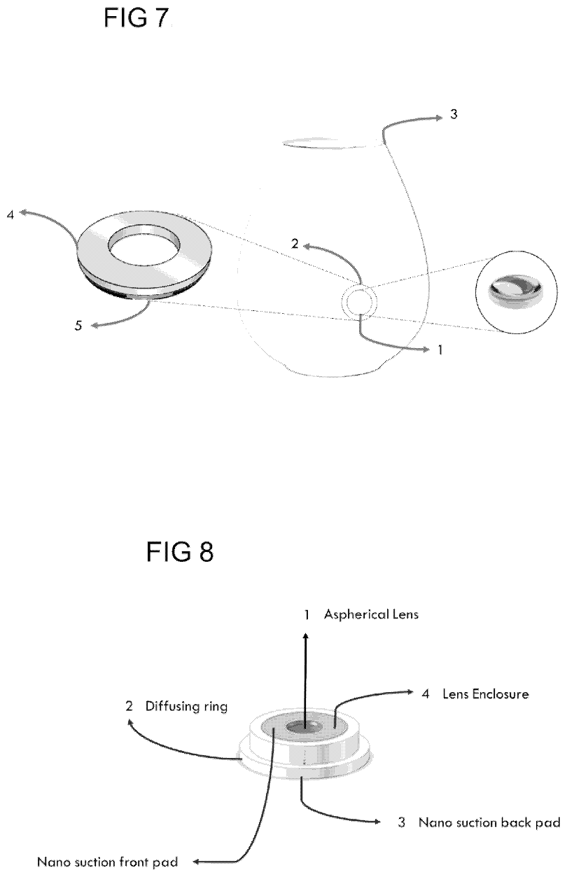

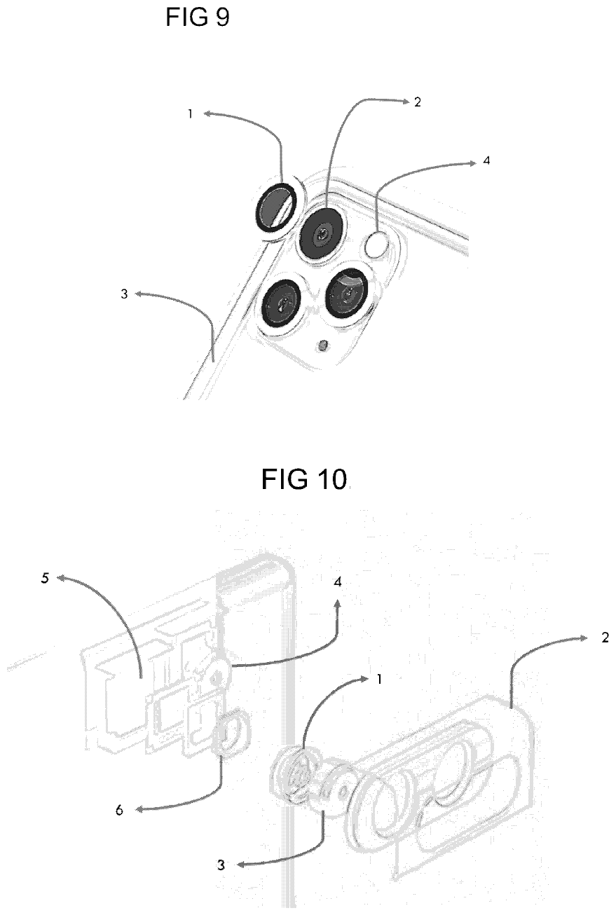

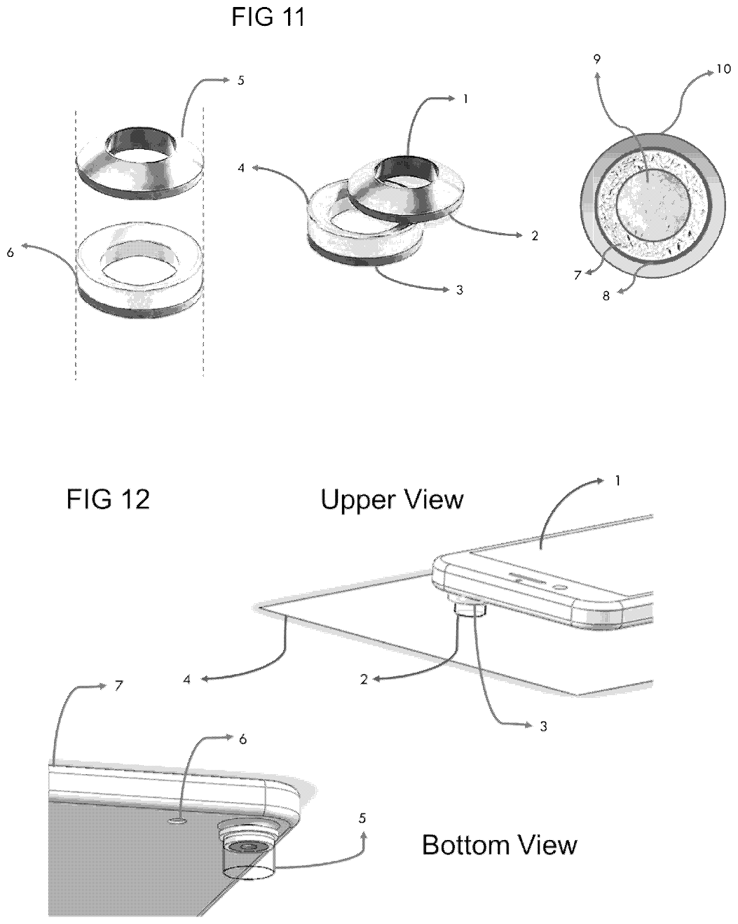

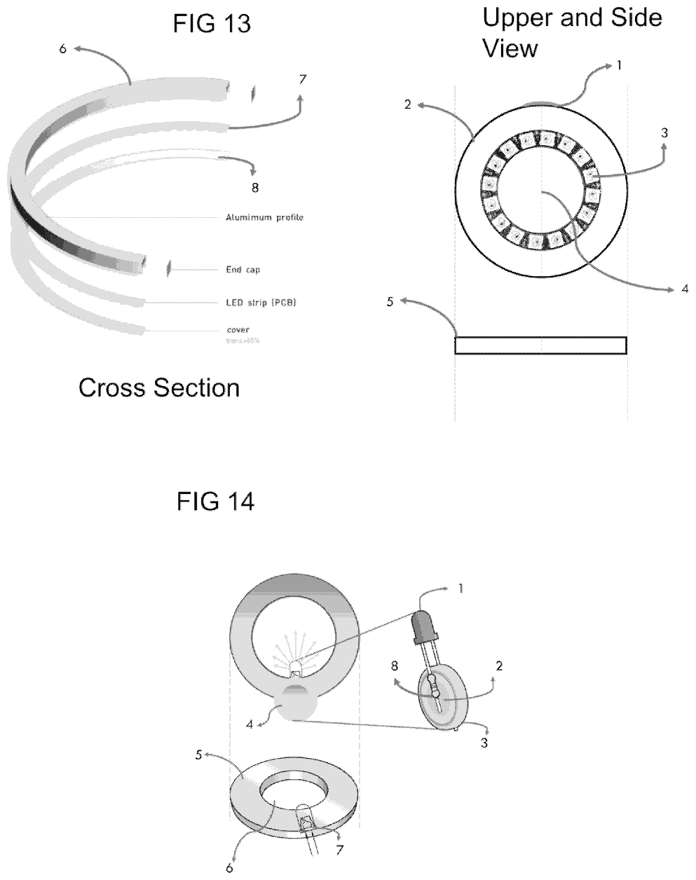

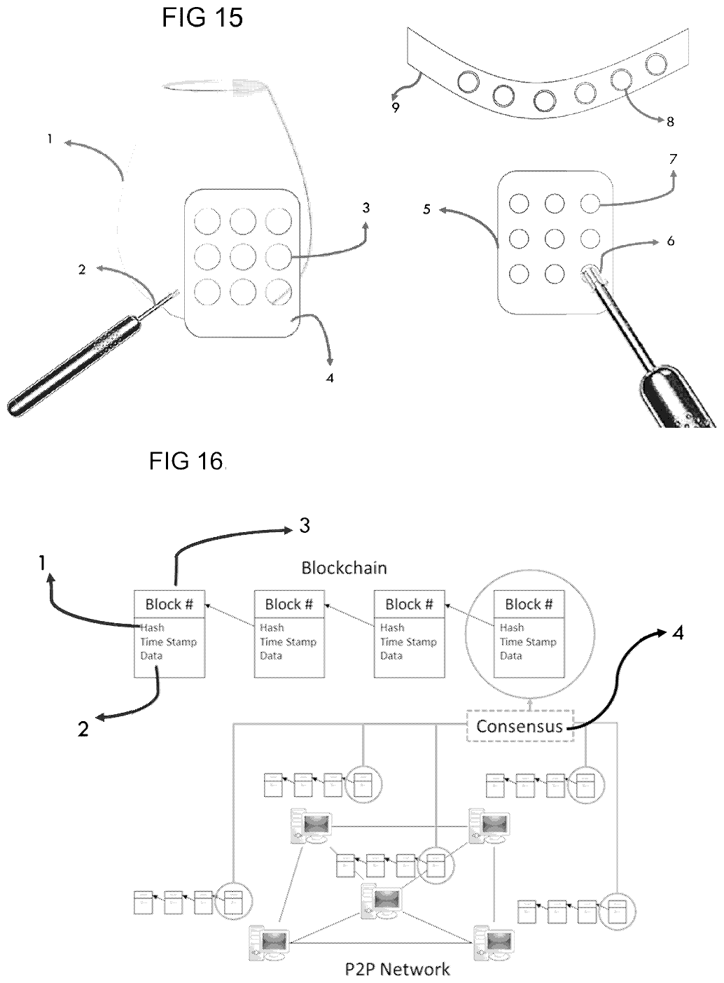

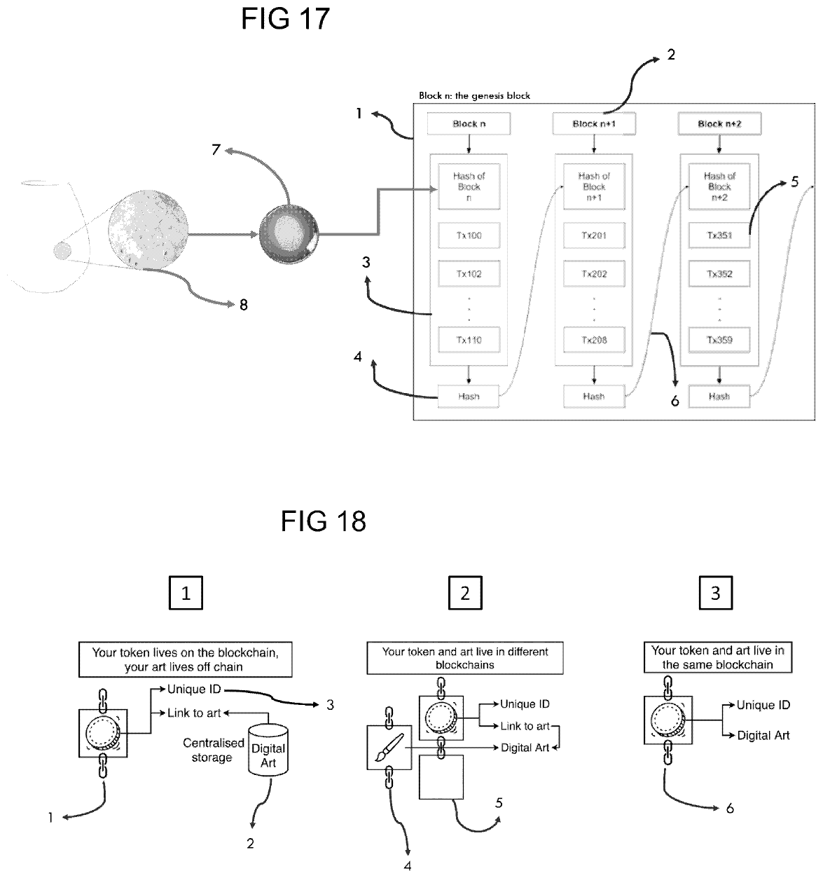

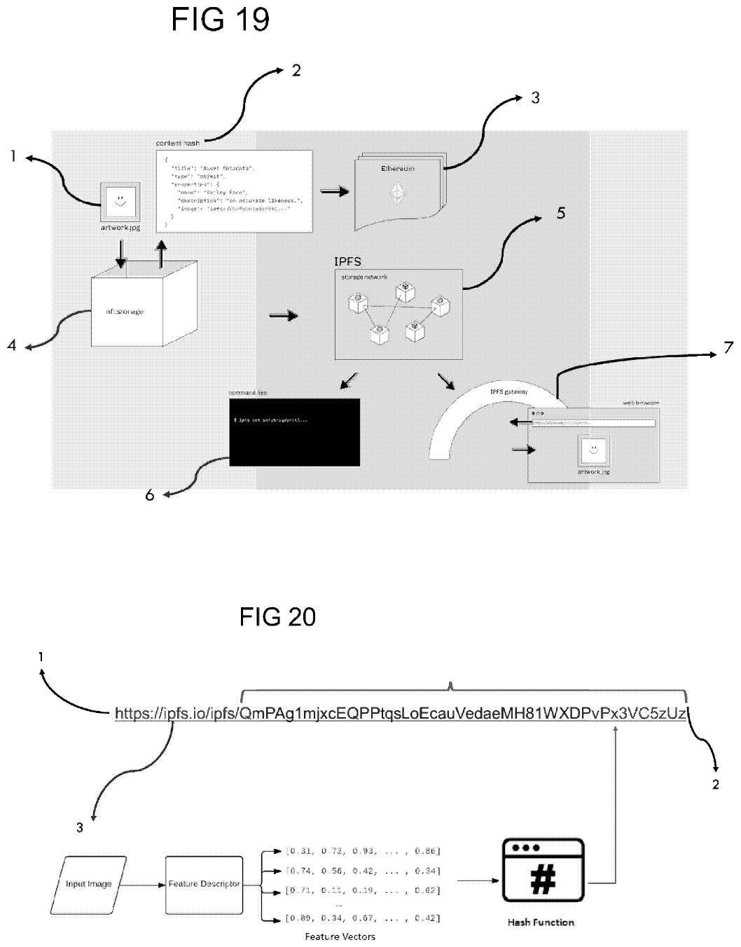

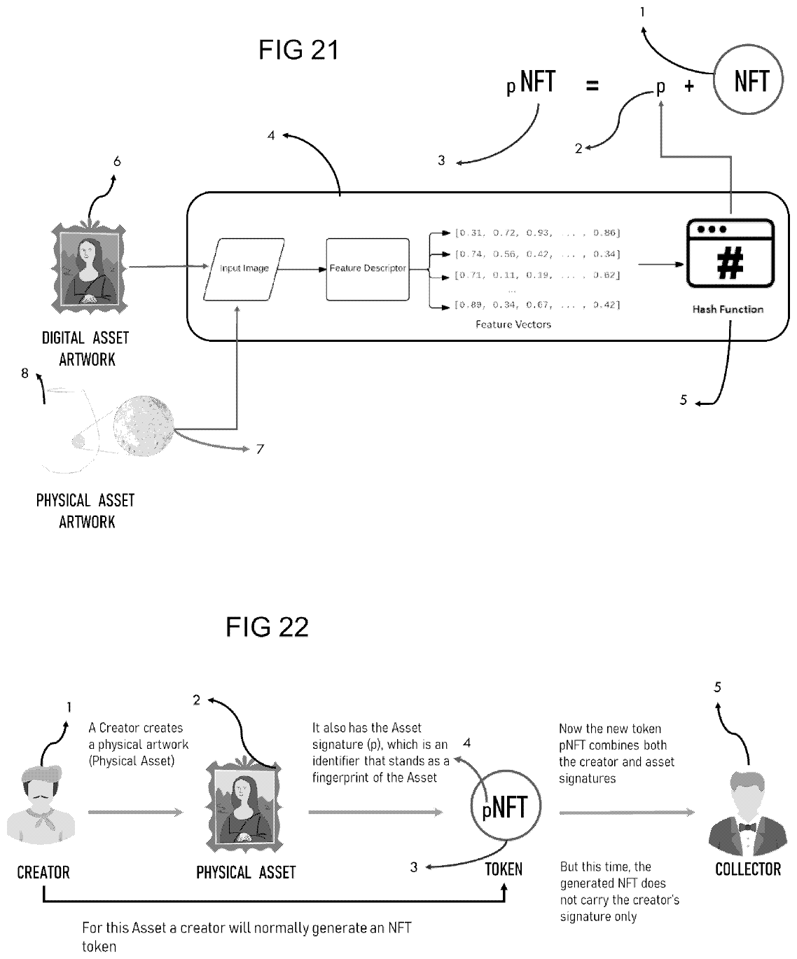

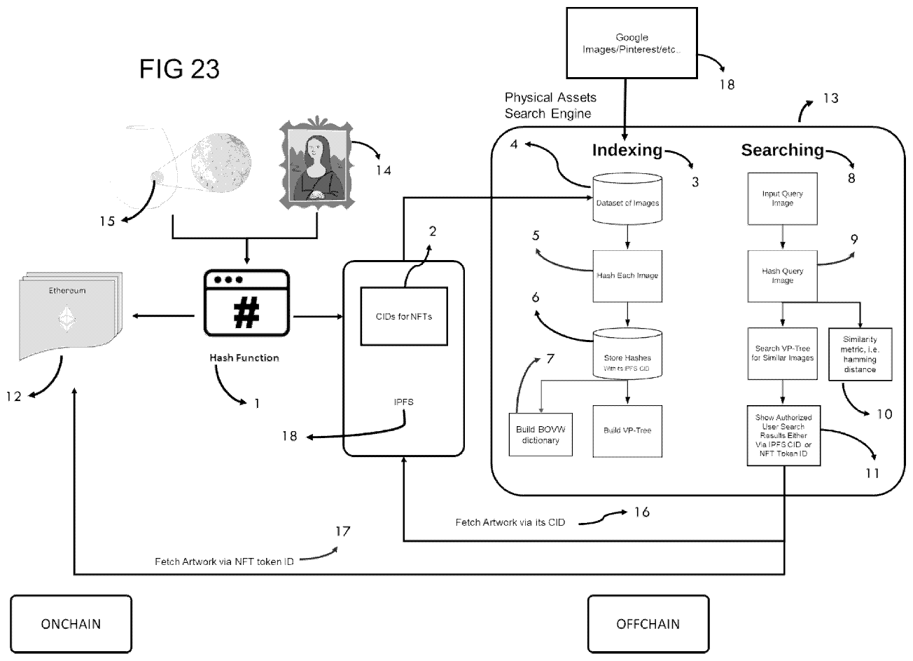

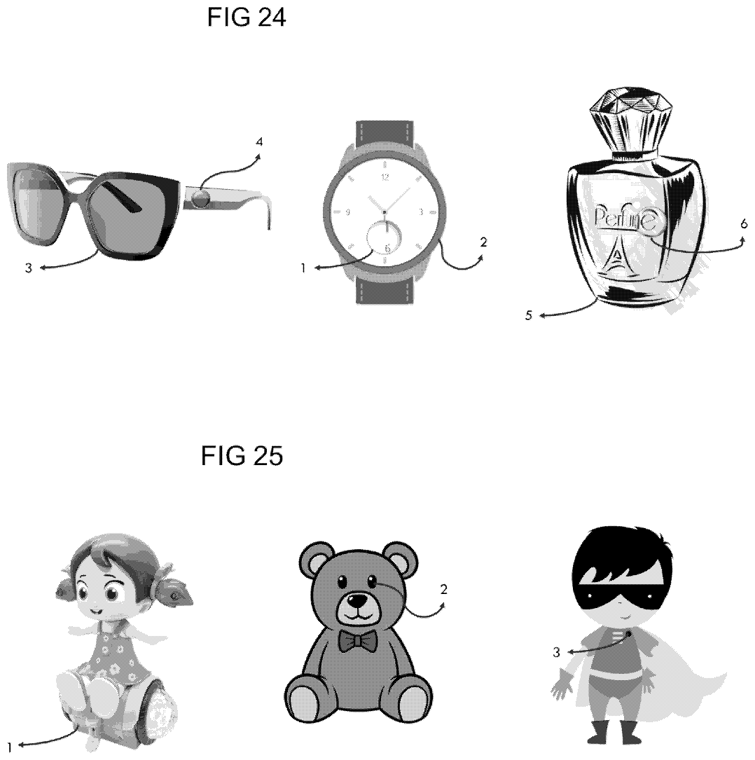

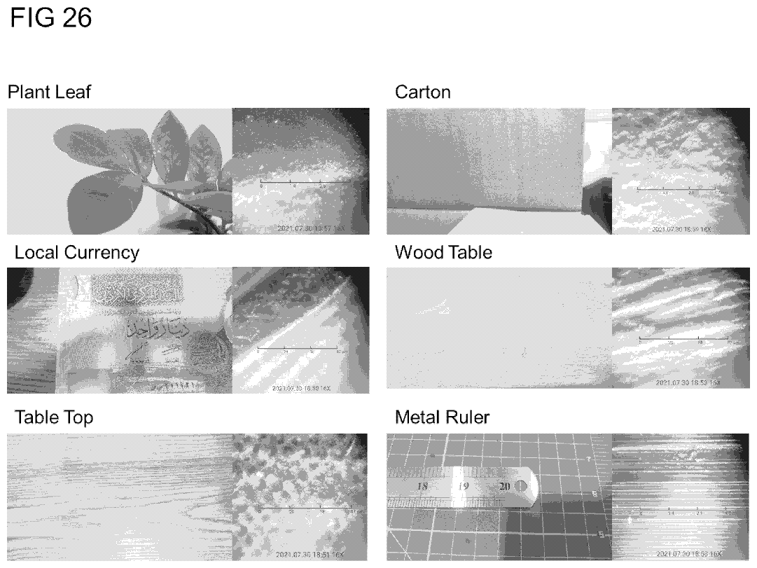

### DESCRIPTION OF FIGURES

The following are details of each figure's description. Some figures constitute what can later become essential claims to be included in the final non-provisional utility application, other figures are more than just indicative, but explanatory to the inventive steps involved and their significance to the application disclosed herein. These figures highlight the most promising real world applications that can result from different NFT innovations in the world of digital ownership of physical and digital assets depicted therein.

FIG. (1): Physical Object Showing a Microscopic Visual Ornament Embedded on its Surface

This figure depicts at (1) a physical item or product with an area of zoom as shown on at (2) which could be arbitrarily chosen to be 2 mm circle. The microscopic view as a result of that area (2) being around 100×-800× magnification shows a unique microscopic visual ornament that is intrinsic to the physical item (3) and is embedded on its surface.

FIG. (2): Physical Object Signature Identities Derived from Visual Ornament Encoding

Having the microscopic ornament (3) as a unique characteristic or identity of nearly any physical item as shown in (1) is a very useful function especially if it can be fed into a computer to process it further to become a unique representative of that physical item in (1), getting to that requires, certain computer vision algorithms (4) that process the microscopic Ornament image in (3) to become a unique representative of the Ornament as its Fingerprint (5).

FIG. (3): Physical Object Fingerprint Signature Storage on a Blockchain Ledger

As described in FIG. (2), we have seen that microscopic Ornaments can be treated as images for further processing and creation of fingerprints for physical items as in (3) and (6) as exemplary items; nearly all physical items possess these Ornaments, say, of a Vase (2) and a baseball bat (7). Further these fingerprints (5), (8) can be stored in a blockchain (1) in its transaction section. In case this blockchain (1) was for an NFT (Non-Fungible Token); the fingerprints become the metadata describing the NFT's physical item.

FIG. (4): Process of Image Hash Creation (Fingerprint)

The process of hash creation or fingerprint (4) from a microscopic Ornament image (1) or any image (2) can be done via a Hash function (3), hash functions come in a variety of forms, some are cryptographic and others are not. Image hash function are characterized by being unique to each image and are small in size, which makes them perfect for on-chain storage on a blockchain network.

FIG. (5): Comparison of a Real Image Size Vs Extracted Features Vs Hashed Image

A small sized full image is depicted in (1) with 1.4 MB of size, by applying feature extraction algorithms as in (2) it can be reduced to 20% of its size as in (1), the last size reduction can be seen at (3) where a hashing function was applied to the image feature vectors in (2) which came from supposedly a microscopic Ornament pattern image (1) acquired off the surface of a physical item. At (3) a hashed image is shown with a massive reduction in size and high fidelity of a repeatable and unique representation of (1), making fingerprints (3) work as a faithful storage for physical items' identities on-chain (on blockchain) occupying a very small vs storing the real image itself which is extremely costly on blockchains like Ethereum. This can be done also for normal NFTs where cryptographic hashing like SHA256 were reported to be used for digital images but are not suitable for physical items microscopic Ornaments, therefore, computer vision hashing algorithms are considered the first to be deployed in this invention context i.e.: for NFTs.

FIG. (6): Conceptual Design of a Pen Like Reading Device or Mining Rig

The pen like device depicted is a wireless camera reading device with a magnifying utility of say 400× zoom that is placed at the head of the camera at an appropriate focal length (1), the camera could be a CMOS 1080p resolution with 4 or more surface mount LED lights (3) that can be dimmed or turned off, furthermore the device has around 30 mm straight neck (5) to make it easier to reach surface of intricate physical objects and be placed on of washer adapters as described in FIG. (10) where one conic washer adapter fits around the cylindrical neck (4) placed on physical object in a female male placement configuration. The device can connect to any WIFI point via its Wi-Fi (6) Tx/Rx module and can be recharged via a USB charging port placed at the bottom (2). The main function of this “mining” rig is to mine the object's fingerprint off its raw images; that is to acquire microscopic Ornaments off the surfaces of physical objects with ease, convenience and speed and further send the images for further processing till their fingerprints are created.

FIG. (7): A Built-In Type of Magnification Utility Attached to a Physical Item is Shown

Illustration of an embedded magnifying utility (6) attached to a physical item (3), having an enclosure and washer adapter as shown in (2) and (4) which is attached to the physical item (3) via an adhesive layer such as 3M disk-like sticker with a doughnut like shape (5) allowing a concentric open circular area inside the washer (2) designed for the microscopic lens (6) to sit and fit inside the washer (2) while all parts (2)+(6) become attached to the physical item's exterior surface (3). The washer adapter (2) also functions not only as a withholding mechanism to the lens (6), but also as a locking mechanism for the mining rig's reading head in described FIG. (6) for non-built in magnification utility reading setups with a full Mining Rig as described in FIG. (6).

FIG. (8): Components of a Detachable Magnifying Utility

This figure shows a full enclosure set (4) for a magnifying/microscopic utility or aspherical lens embodiment capable of magnifications of 400×-800× inside a specially design enclosure having nano suction pads for temporary attachment/detachment from surfaces (3) and (4), the back suction pad (3) is attached to a phone camera lens and the diffusing ring (2) working to diffuse the ambient and flash lights from phone's camera flash onto the physical item surface for sufficient and better illumination.

FIG. (9): Attachment of a Magnifying Utility onto a Smart Phone Camera

This figure shows how the detachable magnifying utility (1) in FIG. (8) is situated and used in conjunction with a smart phone's (3), the smart phone back camera (2) is ideally situated in the back and the magnifying utility can be superimposed on top of it with being both concentric with the slightest effort, while a user can monitor the proper mounting of the magnifying utility (1) onto the phone's camera (2) via the phone's screen.

FIG. (10): Integration of Magnifying Utility into a Smart Phone Camera Embodiment

Another setup where the inventors envision the magnifying utility could have been installed for the purpose of having “NFT-ready” phones, is to have the magnification utility (1) readily integrated inside the phone and on top of one of the smart phone's cameras at the back (5) while leaving the other camera for normal usage (4). Calling the camera at (5) the micro camera, its constituted from the lens mounting brackets and adapters for precise focal length setting (6), the magnifying utility (1) the camera filter (3) and the camera panel enclosure (2).

FIG. (11): Mounting Adapters for Magnifying Utility Attachment to Physical Items and Smartphones Cameras

The mounting adapter are a two set of washer-like discs with conic section to ensure a female-male fit configuration and not slip off the central axis going through the lens's center and the camera's center. Furthermore (6) shows a sticker or double face for attachment on physical items also it can be a nano suction pad for temporary attached/detachment and usage on different physical items, the male washer (5) could have a magnetic property added to its nose like extrusion to make sure both washers clip when in proximity, further washer (5) is set to be attached to a camera phone through a similar nano suction pad as found and shown in FIG. (2) mark (4), while the female washer is normally attached to the physical item.

A special washer having element from (7, 10) on the right shows a Security Washer having its own synthesized PUF or microscopic Ornament at (7) as a doughnut shape ring, above it and upto the perimeter of the outer circular ring (8) comes on top the magnifying lens with a size covering the circle perimeter till the ring at (8), thereby ensuring the lens magnifies the Security Washer own PUF at (7), while (9) is the read through opening looking downward onto a physical item's Ornament showing the PUF or microscopic ornament of said physical item magnified through the lens. The PUF at 9 is normally different than that of said security washer at (7). Lastly (10) shows the outer enclosure of this security washer. This washer is used to make sure that only images taken through this washer and supplied by the inventors is used in conjunction with a smartphone.

FIG. (12): Depth of Field, Focal and Illumination Transparent Phone Camera Adapter for Situating Magnifying Utility

The two views the upper and bottom clearly shows the correct way to mount a magnifying utility (3) onto a smart phone (1) camera (8), while holding the phone with the camera facing downward towards a physical item (4); which is in this case a sheet. The magnifying utility (3) is said to clip on the camera while the user is having the camera on and gradually getting the phone camera in close proximity towards the magnifying utility (3) faced in the correct position and being placed on a straight plane surface as in (4). The bottom phone view (7) depicts how the transparent cylindrical adapter extension (5) makes sure that ambient light of the room, and/or flash light (6) pass through onto the physical item's surface (4) while holding the correct focal distance to ensure the correct depth of field each time an image is acquired.

FIG. (13): Lighting Mechanism on Washer Mounting Adapter for Magnifying Utility

A lighting mechanism for the mounter washer adapters depicted in FIG. (11), shows an embodiment ring (2) which could have a translucent material composition allow light diffusion, an LED array (3) situated concentrically with the adapter washer (2), where washer (4) FIG. (11) is the one being attached to the physical object, (4) is a space whereby the magnification utility fits within, last but not least a toggle button mechanism that works as an on/off circuitry switch to turn the LED array (3) on and off, (5) shows the side view of the same embodiment as in (2). Another embodiment Further details the LED array (7) would be industrially positioned inside an appropriately designed aluminum shell as in (7) whereby it's all enclosed and has a translucent cover as in (8).

FIG. (14): Lighting Mechanism with on/Off Button+Battery

Another simpler lighting mechanism than the one shown in FIG. (13) is shown whereby an LED single light LED (7) and (1) is positioned inside the internal circle perimeter of the adapter mounting washer adapter (5) just besides the magnifying utility area (6) to allow the light traverse the magnification utility and onto the physical item, a simple button enclosure (4) encompasses the toggle button (2) a coin battery (rechargeable or non-rechargeable) (3) and as the LED lights connected via an appropriate resistance (8).

FIG. (15): PIN Code Reading Stencil for Sequencing Against Counterfeiting and Forgery

On some unfavorable occasions the physical item (1) shipped to a certain buyer maybe replaced with a one that looks exactly the same, to prevent that from happening and to ensure that the certificate of ownership (NFT) the buyer had matches the fingerprint p in his pNFT certificate, a reading stencil (4) has been devised as shown whereby each circle (3) of the nine or more locations has a mounting washer adapter opening as in the female counterparts shown in FIG. (11), this setup allows the mining rig in FIG. (6) and shown here at (2) to read through these circle openings (7) of the stencil (5) shown to right of this figure in order to achieve exact concentricity and a fitted coupling as in (6).

As a user works through the stencil going in a predefined pattern or PIN, just like one would open a locked smart phone screen with a PIN code or pattern; the stencil enables reading like a 4 or 5 PIN code as instructed by the received digital pNFT, this PIN makes sure that no parts of the physical item in (1) are manipulated or has been etched to another similarly looking item, moreover, hidden locations for reading the microscopic Ornament off the physical item medium surface can be also found as instruction within the pNFT token to increase level of security. Moreover, the stencil can take other shapes like a bendable shape strip (9) having a different arrangement of PIN holes (8) and can be made from different materials like paper, cartoon, PVC and Aluminum.

FIG. (16): General Blockchain Architecture

This figure shows three essential elements of a generic blockchain system, most importantly the Block itself as a fundamental block and its number as in (3) the Data for each cryptographic transaction within the Block and the Hash (1) or the Chain connecting these blocks. Last but not least the consensus network is shown here as a network of computers and distributed nodes performing the votes and validating each transaction to be true over the whole blockchain network for each block and each transaction of each block; i.e. the consensus.

FIG. (17): Hash Value Inheritance in Blockchain

A major component of any decentralized cryptography network as BlockChain Networks (1) is the Hash value (4) which is calculated by using a cryptographic hash function (a mathematical formula such as SHA-256) that takes into calculation all the block transactions (3) and produces a new one-way direction result of long string of numbers or the Hash (4) that is said to be verifiable by certain protocols like POW (proof of work) and through a process called mining. Hashes are a fundamental component of any blockchain system not only to ensure secure data encryption but also to connect each block with the next block or in other word make the chain (6) and ensure sequential valid immutable transactions (5).

In an ideal setup to register physical items fingerprints (p) (7) belonging to a microscopic Ornament (8) is to initiate the genesis block (n) with the hash value of (p) whereby the chain of blocks register transactions of those belonging to the same NFT token of that said physical item with fingerprint (p). However, in practical cases, transactions appearing at TX100, TX351 (5) can store the value (p) of the related NFT, then any NFT token transaction would always carry the value (p) of that physical asset reflecting an effective ownership or NFT price changes.

FIG. (18): Combining of NFT and Art in Various Storage Configurations

NFTs thrive through blockchain systems as those mentioned in FIG. (16) and FIG. (17) and has common attributes; mainly the hash value of its token transactions. However not, all arts and digital assets that NFTs tokenize are on the same blockchain or even another one (called on chain), some are simply off chain whether the art or its describing metadata that could thrive on other centralized databases. Generally, there are three basic configurations present when dealing with NFTs and their tokenized assets.

The first to the far left [1] is whereby the NFT token in minted (1) (created) on the blockchain with a unique ID (2) and has a pointer (3) inside it pointing to an external storage (4) which could be a centralized database or a p2p distributed network like IPFS.

A very common type of NFT setup is where the art details (metadata) and the art itself live off the chain as its costly to mint it on the chain and keep it there. Setup [2] is where both the token [5] and art/asset are on chain but on different blockchain networks, where art token [4] could be on a much more cost effective blockchains than its NFT's chain. The last setup [3] is where both the token and its art/asset are on chain i.e. on the same blockchain (6) which is less popular as its costly to maintain the art/asset on the same blockchain as users would pay high “Gas” fees on blockchain; this invention makes this setup with the used of (p) hashes to be the most secure, cost-effective and fastest amongst all three.

FIG. (19): NFT and IPFS Networks Use of CID Hashes for Metadata

The common setup described in FIG. (18) for having an NFT configured and minted as stated earlier, where the NFT is minted in the blockchain (3) and only has a pointer (2) that points to the artwork (1) and/or its metadata and stored in (4).

InterPlanatery File System (IPFS) (5) is a distributed system for storing and accessing files, websites, applications, and data. IPFS allows NFTs to represent data of any size and format in a secure, verifiable, and distributed way that can stand the test of time. Once the IPFS create the hash it gives it back to the NFT token to store it and it will serve as an address entailing the contents of this NFT (2). If a user has the hash number or CID, this user can fetch the artwork (1) details through a web browser by putting the IPFS URI in (7) and/or through a command line (6) that all serve as gateways to the IPFS network.

FIG. (20): Anatomy of a Fingerprint in Place of CID Hashes Inside an IPFS

A content identifier, or CID, is a label used to point to material in IPFS. It doesn't indicate where the content is stored, but it forms a kind of address based on the content itself. CIDs are short, regardless of the size of their underlying content. As CIDs are based on the content's cryptographic hash. That means that any difference in the content will produce a different CID and the same content added to two different IPFS nodes using the same settings will produce the same CID.

A Uniform Resource Identifier, or URI (1), is used to specify a particular piece of content in an IPFS system just like a web URL points to a web location. Inside a URI a Content Identifier CID is specified, the same way as a (Hash) codifies certain data, CIDs codify a content based-address like location used to help locate where an artwork data is stored on in an IPFS network (3). As per this invention the CID or “Hash” (1) of a physical item will now be calculated from a series of computer vision algorithms (4) and the final computed hash function value being a BOVW (Bag of Visual Words), or VLADS (Vectors of Locally Aggregated Concepts). So for instance the Hash as in (5) replaces the IPFS CID (2) or in case both the NFT and artwork are on-chain the hash value can be directly placed inside the NFT token transaction as it does not surpass more than 4 byte of data. The benefits of calculating the CID from computer vision hashing like BOVW has benefits that go beyond cryptographic hashes like the ones used for computing the CID from the artwork content itself as in SHA-256, see Claim [8] for more details of the comparison and the benefits.

FIG. (21): Using Computer Vision to Tokenize Assets on the Same NFT Token

The process of creating unique, repeatable and searchable fingerprints out from digital images whether these are normal artworks or microscopic Ornaments of physical items and storing these fingerprints inside an NFT yields a pNFT. This highlights an important methodology underlying tokenization of any asset type using computer vision algorithms; since the same process used to derive a fingerprint for a physical item is the same one for a digital asset since both of them are essentially images, this makes on chain storage of this asset cost effective and searchable by fingerprints search nod matching techniques through a specialized search engine functions depicted in FIG. (23).

A computer vision block (4) passes through four essential steps in deriving a unique hash, after preparing the image, each step is designed based on the image characteristic, shape, texture and pattern characteristics, for example, a unique LBP feature extractor and descriptor is best fit for highly textured images while a Hue descriptor is better for color varying images and so on so forth. After all features are assembled in a feature vector it becomes ready to be quantized; the resulting fingerprint or hash (5) is the same as p in (2). When p is combined with NFT (1) for that same physical asset the pNFT is derived (3), whether the artwork is a digital asset (6) or a physical asset (8) with its microscopic ornament (7) hashed, the resulting pNFT always encodes a unique fingerprint.

FIG. (22): pNFT: The Big Picture

By now and at FIG. (22), the big picture of the pNFT protocol can be simplified and revealed in a simpler user friendly pictorial illustration. As a creator (1) creates a physical artwork (2), then for this asset that creator will normally generate an NFT token, in the same time the fingerprint (p) at (4) is being minted and its fingerprint is hence produced, this (p) is then combined onchain or offchain depending on the used architecture to get the pNFT (3). Now as a collector (5) buys this pNFT, this buyer can make sure that not only the same physical asset beholding the pNFT has been purchased, but also that its claim of ownership carries that physical asset fingerprint too (3). This can be usually checked using the previous methods of reading apparatuses in FIG. (6) to FIG. (9) for later verification. Then the (p) fingerprint signature establishes a secure permanent connection between NFTs and physical assets (i.e. pNFT=Asset Fingerprint (p)+ NFT) and that's why the (p) beholds the code that enables collectors to verify received physical assets received against their pNFT tokens. pNFTs created for all kind of assets now can be truly be owned in a trustless, decentralized manner.

FIG. (23): CID, Artworks, Assets and NFT Search Engines

It has been established through this invention's various figures and illustrations that the (p) fingerprint can be used to replace CIDs in an IPFS protocol, using such hash (p) has further implications, by the use of an inverse image search engine, true everyday useful applications are revealed; whereby someone may not have the physical item at hand or have the digital asset's image and wants to search if these assets have minted NFTs already or not, with the use of the p fingerprint NFTs become readily searchable.

Now, a physical item's microscopic ornament (15) or a digital artwork (14) can be searched in an offchain artwork registry from their CIDs and p fingerprints respectively to yield the digital artwork image or physical asset's image itself, then these fingerprints can indicate whether they are coupled to NFTs and where is the address of its smart contract and what's its token ID.

To better understand the search engine operation, we will go through the accompanying figure workflow, as soon a hash function creates the hash and fed as a CID (2) in an off chain fashion; each CID gets into the indexing phase of the physical asset search engine (13); as all images (4) are already hashed from the CID network; step (5) is skipped, unless images come from a non-NFT source (18) like Google images, Pinterest, etc., they first get hashed with the hashing algorithm that produces (p).

Now as all the hashes are stored in (6), utilizing hashing for instance like a BOVW dictionary (7) or built in a VP tree, they now are said to ready for the search phase, i.e. they become search ready or searchable.

When an image query is made to search its will be used to see if an image has NFT or not and what it's NFT token address is in the smart contract, in case the image is of a physical item or a digital image artwork both can be equally fed to the search engine as in (13). But if the image query came from an already hashed image; then step (9) is skipped as the image has already been created via its hash. At (10) a chosen similarity metric, like hamming distances, are now applied to compare two fingerprints together and if a match is found then this means that this image has an NFT minted for before. A user will get a search result as in (11); the result contains the NFT token ID, its CID and the found asset image as stored in the database. These values can now be either sent to a blockchain (12) to fetch the NFT token directly via its address (17) if its onchain setup; i.e. on blockchain, or to an IPFS network (18) forwarding to it the CID (16) to fetch the NFT token ID first from the IPFS network itself.

Broader applications of this search engine (13) architecture, is that each image say on Google images can have its own NFT created for it on the fly and offered to be sold or auctioned for interested buyer(s), this can be valuable for stock image websites as well whoever wishes to mint an NFT version of an image as well.

FIG. (24): Luxury Products with Built-In Magnification Utility

One of the main applications of NFTs are found in the fashion and luxury world of brands. The luxury business is based on identity prominence and signaling high statuses, therefore, pride plays a central role in the value proposition of these brands. NFTs does a good job tokenizing pride, as NFTs can create limited editions of luxury products such as perfumes, watches and expensive pursues, leather jackets and hand bags. These limited editions have attached to them an pNFT token, so one brand may wish to create only 1,000 piece of its new fragrance even if tens of thousands are sold of this successful perfume edition only 1,000 are truly the limited edition, and hence owners get to elevate and show their status through not only owning the same perfume and being first owners only, but also owning the limited edition of it as well. The embodiment of a sunglasses (3) shows how a beveled magnifying utility is mold into the product to become an integral part of it (4) which can be read off using a smartphone apparatus as mentioned earlier. Likewise, a luxury watch (2) can have an embedded magnifying utility as in (1) to probe the microscopic ornament of this watch. A perfume can have the same utility (6) embodied in a fragrance bottle (5) and so on.

FIG. (25): Toys and Gimmicks with Built-In Magnification Utility

In Toys, limited and special editions, superheroes and superheroines, etc. is another category where pNFTs shine as well, a Girl′ dancing toy can have a magnifying utility (1) embodied as in FIG. (24), a Teddy Bear (2) and Superhero by (3) all contain an embodiment that is placed in a setup ready to be read off.

FIG. (26): Sample Microscopic PUF or Visual Ornaments of Some Real Physical Items

Six adjacent images showing real physical items with their real corresponding microscopic images taken each on one arbitrary region on said physical item representing the microscopic Ornament. Images were taken with a suitable real magnifying utility or lens to show the respective unique visual Ornament or PUF on a microscopic level.

### Detailed Description of the Utility

Most physical assets having intrinsically embedded microscopic visual features on their surfaces can be utilized as identifying components in NFTs, this utilization is one of the main inventive steps that will be the stepping stone on which other concepts and claims of inventiveness interrelate and are based upon.

The key goal is to make each physical asset, in its own right, possess an NFT readiness element through its fingerprint (p) that forms the so called pNFT which has been previously described in this disclosure.

The invention at hand answers the question: how to capitalize on those intrinsic microscopic Ornament features residing on the surface of physical item with the use of a generic smartphone and/or a simple probing or reading device or apparatus, to turn physical assets' identifiers into digitally verifiable certificates, thus solving the isolation or separation problem in NFTs of physical assets between two asset classes; the NFT token and the physical asset for which an NFT token is created or minted.

According to the best knowledge of the inventors and their prior art research, no other invention has devised a similar apparatus from the people skilled in the art or rationalized the use of PUF's to create a pairwise hybrid form of NFT in the fashion depicted herein, containing the fingerprint of the asset (p)+its blockchain token for the purpose of creating a unified inseparable identity (i.e. pNFT) that is both physically and digitally verifiable.

Essential Features of the Initial Claims' List

The following is an initial list of (9) core claim categories or shown below as blocks with (17) anticipated essential main claims-to-be, that details the inventive steps the inventors envisioned necessary to constitute a novel, useful and non-obvious utility patent application; i.e. utilizing physical items' PUFs as identifiers entitling users to claim of ownership by virtue of verifying their assets' fingerprints.

The current list of (17) essential claims have other several dependent claims, making them a total of (27) claims between essential and dependent claims. The below diagram arranges all claim categories in a pictorial and chronological order in terms of inventiveness order and steps needed to be walked through in realizing the invention. Refer to the below boxes for ease of reading and comprehension of how all claims to comprehend how every claim comes together to the bigger picture in participation and creation of the invention at hand.

| Utility | Utility | Method |
|---|---|---|
| Claim 1 | Claim 2 | Claim 3 |
| Utilization of Fingerprints Hashes | Minting Physical Asset | Size reduction of PUF fingerprint |
| as NFT metadata, pNFT | Fingetprints Hashes on Blockchain | enabling onchain NFT storage |
| Process | Apparatus | Process |
| Claim 4 | Claim 5 | Claim 6 |
| Generation of Fingerprints Hashes | Various Reading and mining Rigs | Verification of tokens with |
| from images Feature Vectors | with mounting adapters | searchable NFTs capabilities |
| Method | Method | Method |
| Claim 7 | Claim 8 | Claim 9 |
| Creating an Anti-forgery reading | Embedding PUF Fingerprints in | Making Physical Assets |
| of PUFs via PIN code stencil | place of IPFS CIDs | Intrinsically Limited Edition Items |

1. Claim No. 1: Use of PUFs as Physical Identifiers of Ownership

Using the intrinsic microscopic Ornaments of different physical items as shown samples of as in FIG. (26) or as can be called (Physically Unclonable Functions) PUFs, these microscopic Ornaments are found in most physical items and can be used as a fingerprint for ownership identification when connected to an NFT and/or its metadata. Fingerprints (p) could be stored in conjunction to an NFT on and off chain; i.e.: on or off a blockchain. Specifically, this claim entitles:
(a) A medium comprising as part of it an optically and computationally discernible random pattern/ornament that is naturally occurring, such pattern is located on an arbitrary or creator defined token area found on or in said medium's or on a physical item's surface. Said ornament is microscopically recognizable of which a digital signature or identity can be generated from by use of an optical apparatus and a processor unit, these fingerprints serve as unclonable identifiers for said medium for purposes of recognizing the medium in possession. Consult with FIG. (1) and FIG. (2) for a pictorial illustration of this claim.
(b) A method whereby said medium of some physical item/product fingerprint is linked to its minted NFT thereby constituting an inseparable identity for said physical medium or artwork from its minted NFT. The new entity named, pNFT, is a digital NFT, see FIG. (22), with its metadata thereof storing said fingerprint denoted as (p), hence pNFTs merge and consolidate two entities (the fingerprint (p) and the NFT token) forming an inseparable certificate of ownership: the pNFT for said physical item or asset.
(c) A method for generating PUF fingerprints that are counterfeit-proof, as such these PUFs are unclonable unlike other identification and tagging methods of physical items such as QR codes, NFCs, RFIDs and other forms of physical identifiers that are all prone to vulnerabilities due to the ease of which they can be ceased, cloned and detached from their physical counterparts and, therefore, cannot be as pervasive and as perpetual as (p) fingerprints generated from microscopic PUFs that are essentially an integral part of the physical item or asset in question.

### Description

Any physical item comprising an optically discernible microscopic ornament, said ornament having characteristics of being capable of providing unique fingerprint reference information for specific areas on said physical item; when said physical item having a replica fingerprint generated from the said microscopic discernible Ornament image residing at a database, then two fingerprints can be compared and tell if the item at hand is the same said physical item or not simply by comparing the fingerprint read from a physical item and the replica one in a database.
In this disclosure, a new way has been established for identifying physical items not from their aesthetics, texture and exterior characteristics, this new invented method was made with the following purpose in mind: facilitating physical asset “digital” ownership, exchange and verification.
A need for such innovation is emerging in today's marketplaces known as NFTs, specifically, the importance of the ability to identify an object whether physical or digital by its tokenized Certificate of Ownership i.e.: NFT, is becoming of paramount value, because NFTs created a new class of assets whereby the act of token “ownership” becomes a separate and more valuable asset class from the underlying assets itself, therefore, the need to perpetually link ownership to assets of all kinds at all times becomes the key of physical NFTs.
However, in physical items, tokenizing ownership as separate digital “assets” in the form of NFT stalled and stumbled with many downturns as there exist no universal, ubiquitous and reliable linkages between the ownership “token”, its owner and the tokenized physical item itself, and without such robust connection, NFTs of physical items quickly renders physical NFTs worthless.
Fingerprints (p) of physical assets play a central role in identifying a physical item to be the same exact one tokenized at first-hand, because the fingerprint (p) is an intrinsic property of said mediums and physical items, the (p) fingerprint creates the needed relation or bridge that works as the connection between a physical asset to its digital ownership certificate; and thereby to its beholding current owner of the tokenized certificate or NFT, as such that the digital certificate always holds the value (p) and the value (p) always represents the physical asset image and its certificate of ownership. As the focus of NFTs is on the whether the person is able to maintain the ownership relationship against an asset at all times and transfer that ownership to someone else whenever needed, fingerprints (p), become the custodian for this ownership relationship in the physical world.

2. Claim No. 2—Minting Asset Fingerprint on Blockchain

In the latter Claim [1], it has been established the fingerprints (p) are the bedrock of ownership for physical items in the world of NFTs or the new certificate of ownership asset class, in this claim storing these signatures or digital fingerprints (p) as identifiers of ownership on a blockchain network including but not limited to the transactions and/or hash headers, renders these fingerprints and their ownership truly intact from change, forging, mutation and or cloning. Specifically, this claim entitles:
(a) A means for minting and registering relevant fingerprints of said physical assets on said blockchain as depicted in FIG. (3) and FIG. (16) and FIG. (17). As such, said Fingerprints initiate the starting block known as the genesis block for an NFT equating its Header Hash to the asset fingerprint Hash (p) or simply put (p) in the transaction blocks with the same value as in FIG. (17), later transactions of the same NFT could be also recorded and pointing to the same value (p) as well, while (p) values are always coupled with the NFT token ID and address. Blockchain storage of said fingerprints (p) of said physical items ensures that physical assets become blockchain indexed in a decentralized, immutable and unclonable fashion by virtue of blockchain architecture, and, therefore claimed ownership authenticity of physical items becomes a virtue of the said fingerprint (p) stored in an immutable fashion.
(b) A verification means for physical items originality; withstanding the latter claim (a); a merchant or a vendor having a verified account at a marketplace, platform or a blockchain could claim and ensure physical items authenticity by having said fingerprints (p) of sold physical items on said blockchain. Said merchant or vendor having a verified account on a marketplace; could not only provide certificates of ownership of said physical items to their customers, i.e. NFTs, but can also ensure these physical items are of true origin and belong to the vendor's own authentic make or brand, as such customers trusting a certain online marketplace denoting that a certain vendor's account is a true trusted account legitimately representing a specific brand, makes buying pNFT-enabled products from said vendor's account a true sign of said products genuinity; as only said vendor could have minted products' pNFT tokens at time of produce and release to markets via said online marketplace.

### Description

A decentralized network such as blockchain, where said medium or physical item, comprising an optically discernible microscopic pattern or ornament having their derived fingerprints recorded as the Hashes inside the block transactions, normally each subsequent child block FIG. (17) calculates its new hash from the previous parent block hash value and the minting of new transactions are related to the same NFT token. The voting, validation and consensus across the blockchain for that transaction is left to the nature and operation of the selected blockchain, such as Ethereum blockchain, but the very basic minting of the first NFT requires the Hash to be mined and stored in the blockchain transactions header. This process is equally essential to also digital artwork assets, as they can have a fingerprint (p) calculated from their artwork image, which constructs a new blockchain architecture for NFT; the pNFT, whereby the token and the artwork live in a highly secure manner.

Vendors of physical items entering the world of NFT, might at first struggle with the concept of NFT whereby a certificate of ownership of a certain physical item is worth more than the physical item itself with disregard to its authenticity. As expected, such vendors concern always how to make their physical items or products difficult to counterfeit and not dilute their value instead by some token or claim of ownership certificate. However, with this claim; pNFTs can strengthen the originality claim as well as the authenticity of the physical items being sold themselves; having fingerprints (p) always identifying a physical item in an inseparable and unclonable fashion can become an equally strong evidence of authenticity of the vendors or merchant physical items sold only if those vendors happen to have a verified account on the marketplaces where their customers buy their pNFT coupled physical products.

3. Claim No. 3—on Chain Physical Metadata

Claims [1] and [2] introduced the concept of (p) as an Ownership Identifier or proof and also detailed the benefits of minting this fingerprint on a blockchain, but one of the challenges to reap all the benefits of tokenizing the ownership of physical asset pNFT onchain (i.e. on the same blockchain) is that the NFT token size normally has limits and is prohibitively costly to store artwork data on the chain, in a way, that only such data must be of infinitesimal size to live on the blockchain without the penalty of high “Gas” fees and storage limitations or the need to resort to third party p2p offchain reconciliation networks for storing the metadata of the physical item. In this claim it has been postulated a method of how to transform a physical item's microscopic Ornament or a digital artwork into its fingerprint (p), which is infinitesimal in size, yet is highly unique and repeatedly reproduced; consult with FIG. (4) and FIG. (5) for highlighting the process of fingerprint (p) size reduction. Specifically, this claim entitles:
(a) A tool devised and adapted from modern computer vision toolkits to create and manipulate images with potent amounts of information and derive decisions on exiting input and inferred data. Fingerprints are a produce of image information feature extraction and reduction, therefore, a PUF ornament on a microscopic level is treated as an input image to the devised computer vision system, at first an appropriate feature extractor is deployed and afterwards all relevant feature vectors are stored therein, last but not least vector quantization and dimensionality reduction algorithms are applied to reach a repeatable, unique, content rich and most importantly very confined data string size that usually does not exceed 4 Bytes of data.
(b) Means for fractional ownership of NFT or divisibility of physical items ownership, in some practical contexts, having a fingerprint (p) onchain makes a physical item's ownership divisible; or can be owned by more than one owner with each owning their respective share provided that each have the value (p) of the divisible item's fingerprint in their different NFT tokens, or having different values of (p) belonging to the same physical item but taken from different locations of microscopic Ornaments on it, but still all reference the same NFT token.

4. Claim No. 4—Fingerprint Generation for Asset Tokenization

Claims [1[, [2] and [3] can be viewed as a sequence or a logical thought process in going through the needed steps of taking physical items and making them non-fungible, even though hundreds of identical, say, pottery pots coming out from the same factory line, still each can have its own fingerprint (p) in contrary to digital artwork, where identical images defy the rarity principle in NFTs. In the physical world rarity among identical items translates into limited editions or special editions, whereas rarity in the digital world manifests in a synthesized collection or a group of individual artwork each being unique and different from the other that are released once in a life time as a sign of rarity. In this claim [4], a process for generating Fingerprints (p) as shown in FIG. (21) is described, which is needed for asset-rarity and ownership tokenization. By transforming any image whether a digital portrait or a Microscopic Ornament into a Fingerprint it can be finally tokenized on blockchain as it becomes a representative of the underlying digital asset or physical item; an NFT certificate. Specifically, this claim entitles:
(a) A processor configured to receive said magnified and processed optical image information and perform numerical and software processing operations on said image to detect and extract special features known visual features that are not deterministic or comprehendible by humans but only recognizable with the help of computer vision algorithms. Upon subsequent feature recognition and extraction, a processor derives and generates a digital fingerprint uniquely associated for each optical image information containing the said digital or microscopic Ornament token image earlier acquired from said input device.
(b) A means for reproducing robust fingerprints that are tolerant to changing illumination or camera pixel readouts during optical image acquisition via said magnification utility for said microscopic Ornament on said physical item. As such, even with slight illumination changes, image acquisition devices do generate identical images, but said images may have unnoticeable variances to the naked eye on pixel levels, however, with such variances when said images are hashed directly via cryptographic hashes used in CID of IPFS networks like SHA256 the output hash becomes extremely susceptible to single pixel changes and, therefore, yield a completely different hash altogether, whereas the hashing method devised in this Claim is more robust in generating nearly the same hash (fingerprint) each time even though with existence of slight and normal illumination variances and/or slight changes in CMOS camera pixel readouts. In this claim said hashing algorithm is designed in such a way that it can always yield and consistently produce the same result when comparison of two fingerprints occurs, whereby one is found on a recorded database or blockchain earlier of the same physical item while the other is the one being acquired from same said physical item. Matching between the two fingerprints is found using special similarity metrics like the Hamming distance.

### Description

A processor means, said processor means being operable to receive processed optical image information from said input means, said processor means is capable of calculating and associating said processed optical image information with a unique fingerprint of said physical item in relation to the microscopic physical item's Ornament image on said surface of said physical medium, item or asset.

### Dependent Claims

1. Image acquisition processor means equipped with an image acquisition hardware that most commonly uses a CMOS camera and lens system, processor means further possesses digital image creation and storage functionality for further processing.
2. Feature Detection. Said processor has image processing capabilities such as filtering of the said acquired image, image processing also removes any RGB channel from the said acquired image. Processor having an ARM architecture and running offline software libraries like OpenCV, said library is capable of running feature detection algorithms capable of dealing with various feature descriptors algorithms such as SIFT or SURF or ORB, LBP or any feature suitable detection algorithms, such algorithms are said to be scale, perspective and rotation invariant of the viewing plane of the said microscopic Ornament image. Said feature detector creates a list of key feature points that characterise the topology of the Ornament token image found on said medium and acquired via said input devise. All extracted features are organized in a feature vector. Choice and/or design of feature descriptors that depends on Ornament texture nature and random pattern or prevalent visual consistencies could make certain descriptors more efficient than others
3. Fingerprinting. After a processor means performs feature detection on said image pattern token; processor computer vision algorithms digitize or quantizes said keypoints in said detected features from their vector features; vectorization or hashing algorithms create a unique index for said vector feature of said microscopic Ornament image, said hashing as such is said to be unique, repeatable and small in size and act like a fingerprint of said medium or the physical item's Ornament. Hash generating fingerprinting algorithms may be performed via the likes of, but are not limited to, LSH, PCA, BOVW, VLAD, perceptual and possibly some modified cryptographic hashing. Some of the results that were generated in the reduced to practice prototype were made possible by using Bags of Visual Words BOVW hashing.

5. Claim No. 5—Reading Probes and Mining Rims

Standalone device that has processor capabilities with image acquisition features and is able to perform computer vision software operations with wireless transmission capabilities of encrypted wireless data to a WiFi point directly functioning as an IoT (Internet of Things) device or connect to a proximity user phone. This device could be also an add-on device with magnification and/or image acquisition features only. For convenience, the reading apparatus whether having processor capabilities or not is called and referred herein in this application as a Mining Rig; as the name entails, this Rig mines the fingerprints and “extracts” them off the surface of physical items. Specifically, this claim entitles:
(a) An input/reader device configured to capture, process and transmit optical image information corresponding to a fingerprint ID on said Ornament area or to a processor for further processing. Processor steps including image processing, feature detection and extraction and finally fingerprint or hash generation as detailed in Claim [4].
Furthermore, said input device being configured to capture one or more optical images of said pattern token or ornament on the surface of said medium and to process and transmit said processed optical image information to a processor means via optical or electrical signals, said input device may have an independent on board processor means to carry optical pattern discerning; said input device may have any form factor like a credit card, or a coin-like form and dimensions for ease of use, handling and mobility.
(b) A security means for reading microscopic Ornaments off physical items such that the Ornament image reading app is connected to the fingerprints generation software and fingerprints storage database respectively as in Claims [4], [6] via encrypted end-end communication. Moreover, said image reading app or webapp does not accept reading off images of physical items microscopic Ornaments during the fingerprints mining “generation” process. Also, for increased security and preventing someone from feeding false PUF images, the Mining Rigs software app is designed to read only from a live feed of microscopic Ornaments coming off said physical items via a smartphone camera only through a dedicated mounting washer called the Security Washer described in FIG. (11) with image marks at (7, 8, 9, 10). With said security washer having its own intrinsic microscopic Ornament, when someone using a smart phone's camera, both PUFs are recognized; the Security Washer and the physical items' Ornament. In case the security washer does not appear to be present this mining process is considered invalid. The benefits of having the security washer are two folds; if someone happens to itch off the Physical items' microscopic Ornament's physical area, this attacker, will have a hard time getting any use of this patch; as there is no security washer in the possession of this attacker to correctly read and generate the physical item's fingerprint, because pre-stored database of minted tokens with values (p) expects to also see the fingerprint (wp) which is the washer's (p) fingerprint, second, even if someone prints a large scale image of an Ornament and puts it at a fairly large distance in front of a high resolution phone camera operating the proprietary mining rig app in an attempt to deceive the forgoing system, the security washer would render this attempt impractical as the acquired images of the two concentric PUFs would look unproportioned, not to mention the security washer obstructing large parts of the distant field of view of the fake printed PUF on a large, say, A4 paper due to the two PUF images being non-coplanar.
(c) A security feature, the said mining rigs described therein, are said to have variable zoom and illumination. In case a user goes with more zoom from 400× to 600× or 800× the security features of the examined PUF or microscopic Ornament fed into the mining Rig would generating a more secure and unclonable fingerprint (p); as more in-depth details increase the difficulty of anyone to craft a microscopically identical surface structure at unheard of scales like 10 microns-50 micron-100 microns and counterfeiting such Ornaments becomes a near impossible if not an impossible task.

### Description

Magnification Utility, is the first essential step and common across the variety of all Mining Rigs described herein in this claim. The input device or Mining Rig main element is its magnification utility made in contact with said physical item or medium, the head of the mining Rig is a microscopic lens that brings about the needed details of the discernible Ornament/pattern found on said medium for proper acquisition and later processing via computer vision systems, the microscopic lens also can be situated via a special suction, magnetic, or adhesive material onto a smartphone camera and can operate in conjunction with the said input/reader device. In all setups, the magnification lens sits on top of the said physical item's surface in a specially designed coin-like shape and having a sufficient illumination shed on the acquired said microscopic Ornament random pattern area.

### Dependent Claims

1. Medium Integrated Microscope: As depicted in FIG. (7), it shows said physical item with attached lens via mounting washer adapter that sticks onto said physical item surface and has a suction lick mechanism to temporarily attach on a smart phone camera. Making the magnifying utility an integral part of the said medium has benefits of making it readily readable with no special apparatus needed from the side of the user. As described in the latter claim description this integrated microscope is also considered one type of Mining Rigs envisioned by this application. Integrable magnification utility is a novel invention that turns any physical item into an NFT-ready piece of artwork or physical item.
2. Mounting Washer-Adapter Mechanism As shown in FIG. (11), two washers are depicted where two cups that can be inserted each other, one cup the “female” washer type is attached on the said physical item as shown in the figure and works to hold the magnifying lens inside it as an enclosure, while the other one the “male” type is an detachable cone line washer that can be attached via a special nano-suction pad on the smart-phone camera and clips on the female washer with magnetic mechanism that ensures both washers become concentric. Another setup of a washer adapter indicating where to read-off or mine fingerprints, is a simple mark utilized as a sticker paper-like or vinyl made in the shape of a doughnut ring attached on the physical item's surface, to indicate where a mining rig needs to read off the microscopic Ornament area.
3. Lighting System Therein, FIG. (12), FIG. (13) and FIG. (14) detail the lighting mechanism of some of the most common Mining Rigs configurations depicted as per this disclosure, in particular, a lighting mechanism increases the illumination of the examined or read microscopic Ornament enhancing the visibility of the discernible pattern of said physical item via said magnification utility detailed in dependent claim (1). Such lighting can be positioned and instilled onto the washer adapter in dependent claim (2) by situating surface mount light emitting diodes (LEDs) emitting light through a light diffusing element for uniformly distributing the light in a lateral of perpendicular orientation in a doughnut like shape enclosure, whereas the magnifying utility is concentric to the disk and the said lighting doughnut element. Other configurations, like the one in FIG. (14) shows an on/off button in conjunction to the adapter washer to control light turning on when in use and off when not in use by a user to preserve battery and extend its lifetime. Such battery could be rechargeable or of a disposable type. FIG. (12) shows a transparent extension cylinder as part of the mounting wash adapter extension that allows ambient or flash light coming from the surroundings or from the smartphone back flash light to penetrate through the magnifying utility and onto the Ornament pattern giving sufficient illumination needed for a clear optical image acquisition of the Ornament and its necessary feature details.
4. Background Lighting or backlit lighting of physical items like a cheque, a bank note, a paper certificate or simply an A4 paper would make the microscopic Ornament features more prominent and therefore the generated fingerprint (p) become more unique. As such and in some contexts the lighting mechanism may come from underneath the physical item facing the image acquisition or mining rig reading camera coming from above and where the physical item sits in between.
5. Smartphone Based Add-ons
All the figures as in FIG. (8), FIG. (9) and FIG. (12) pictorially illustrate how a universal magnifying utility as in FIG. (8), when needed, attaches and detaches as an add-on onto virtually any smartphone camera. FIG. (9) shows the magnifying utility as in FIG. (8) placed on one of the cameras of a typical modern day smartphone, similarly FIG. (12) shows the add-on in operation while tangling onto the smart phone looking downward towards a physical item, said magnifying utility attaches with enough force to the outer transparent protector of smart camera via a detachable nano suction mechanism found on the said magnifying utility's adjacent surface (3) as in FIG. (8). The use of add-on microscope magnifying utility to acquire said image fingerprints for the purpose of creating as in Claim[1] an NFT identity token has not been reported before in the prior art.
6. Smartphone Based Integrations
As with the matter of all industry convergences and commoditization of every day consumer electronics, the invention at hand envisions with the widespread of pNFTs as a way to transfer ownership between consumers of all physical items, at some point, the need would emerge to integrate a special “pNFT” lens within the chase of modern smartphones. A special magnifying utility would with magnifications going from 200×-400×-800× transforming a smartphone as a special purpose Mining Rig for physical NFTs. FIG. (10) details the insertion of a special magnification lens into the internal optical system of the smart phone cameras, such design would work with washer adapters as in dependent claim (2). Furthermore, the washer mechanism might be also built in the smartphone in FIG. (10) by having a internal circle grooving that surrounds the smartphone camera and works as a female counter part to accept a corresponding male washer found on the physical item attached, this male extrudes an inverse circle that comes with same perimeter and width to ensure proper fit with the on phone grooved female circle embodiment. As such depicting an NFT smartphone with integrated microscopic lens has not been reported in the art before this application considering how valuable of an inventive step it would be in bringing this utility to concerned marketplaces.
7. Pen-Like Standalone Device
As in FIG. (6), a pen like design Mining Rig is fully required with optical image acquisition and transmission without process capabilities, it combined a dedicated CMOS camera with LED's built into the camera head in a concentric fashion, with a magnifying utility correctly placed at the right focal distance of the CMOS camera such that the Ornament on said physical item is appropriately magnified, also the neck (4) as in FIG. (6) of the camera connecting to the rest of the pen-lime device is necessary to have a precision operation when reading small Ornament areas on delicate objects or miniature surfaces whereby the use of a smartphone would not be appropriate.

Utilizing wireless connectivity in the form of Wi-Fi makes this device truly ubiquitous in terms of the ability to opt-in on-demand into the world wide web and its thereof services, either directly as an IoT device or through a smart phone which can also be connected to via a Bluetooth or WiFi wireless connection.

6. Claim No. 6—Verification of Tokens Via Searchable NFTs

One can view the NFT world as the operating system (OS) of ownership or the Internet of Assets or Goods, however, today NFTs are tantamount to what does DOS operating system was in the early-80 s, there is no Graphical User Interface (GUI) for the layman to use, and NFTs are still for the “nerds” and not for the public mainstream consumer. Or more accurately put, NFTs resemble the early days of the internet were online directories existed as search engines were still not there. Searching pNFTs by physical item image, or digital image is a requirement for mass adoption just like a search engine was a platform for mass adoption of the internet; because today one can only buy an NFT only if someone goes for a specific marketplace or a “directory” like the early days of the internet were you would go to Web Directories to access websites. Similarly, in a directory-like NFT marketplace, you look up an NFT by browsing through images or by having the NFT token ID and smart contract address. This claim depicts how verifying the mined fingerprints with ones stored on-chain (on blockchain) or offchain make them readily searchable by different types of more convenient que forms, like images or even words. Imagine someone standing at a store front, or browsing the internet or even surfing through e-commerce websites like Amazon.com or Etsy or eBay, with a pNFT search engine, users can now instantly fetch if a certain product or artwork has an pNFT certificate attached to it, reveal its publically declared owner, know its current price and if it's under auction or not. Specifically, this claim entitles:
(a) Searching means to match and associate said digital fingerprint or hash of said microscopic Ornament or the digital image of the artwork to decide if a certain artwork, physical item or product has an pNFT, the returning result of a found hash occurs when a near exact hash or fingerprint of pre-stored in the pNFT search engine database returns a match. FIG. (23) depicts a fingerprint search engine, in this figure an indexing phase and searching phase are shown. Indexing is used to store pre-mined fingerprints known with their equivalent pNFT Token IDs for later comparison, while the search phase fetches fed fingerprints for found pNFTs. The two said phases both start with feeding the hash of the desired image either from a physical item microscopic Ornament or from a digital artwork, an intermediary stage could be used via an IPFS network (18) by replacing CIDs as in Claim [8] by fingerprints produced as in Claim [4]. After the Hash is fed into the search engine it passes through stages described in detail as before in the description of FIG. (23). After the search is completed, the search engine returns a matching hash with its NFT token ID, then the artwork's pNFT is either fetched through, say, an IPFS from its matching Hash if it was offchain then to the designated blockchain from the smart contract address and pNFT token ID or directly on the relevant blockchain for onchain retrieval if it was onchain stored.

### Description

pNFT Search Engine, entails that huge amounts of data reside on the internet belonging to billions of digital goods and physical goods alike are now all possible to have their own pNFTs and be search as well. The search engine basic architecture depicted in FIG. (23) resembles an actual build or reduction to practice of actual search engine that can retrieve matched data in the realm of milliseconds, making it a practical piece of online software for everyday browsing, bidding and trading of pNFTs.

This claim combines three separated systems that have not worked in conjunction before all at the same codebase: these are a blockchain, an IPFS and an Image Search Engine or particularly a reverse-image search engine, with all interrelated these can work asynchronously, with the speed of search engines, the security of blockchain and the p2p storage of IPFS. The combination of the latter systems, the present Claim, represents the state of the art technologies not before combined and integrated in the fashion nor for the purpose depicted herein, therefore, such pNFT token search engine system has not been created before in the prior art by any of those skilled in the art, and could be a stepping stone towards a new era of decentralized ownership of all assets types going mainstream.

7. Claim 7—(Anti-Forging Reading Apparatus)

Physical items and shipping of expensive artifacts could be prone for meticulous forgery, therefore, one area where pNFTs might face a vulnerability is in shipping; if a counterfeiter happens to intervene in the shipping process between a seller and a buyer, although, highly unlikely, this counterfeiter may try to replace an original item with a copycat. As far as NFTs are concerned that's not a problem, because the certificate of ownership is already worth multiples than the underlying asset! However, because the pNFT is attached to the fingerprint extracted or mined off the physical item's surface, someone who might be able to etch that surface containing said (p) and place it onto another one still remains a possibility.

Although, NFTs transfer ownership through a token, stealing the physical item of this token defies the whole purpose of stealing in the first place! The original “stolen” physical item having said token is now worthless, because it has a missing patch in place of its original microscopic Ornament or another patch with different fingerprint (p), as there is no way to physically craft an identical microscopically fingerprint to the one stolen or itched but to place it on a copycat of that original physical item, even though it soon becomes not a worthwhile pursuit, as the value will always reside in the pNFT token and its counterpart on the said physical (the physical microscopic Ornament), even though still the stolen original nor the copycat physical items has the most value concentration in comparison to the accompanying pNFT.

Therefore, selling the stolen physical item to a new owner without its pNFT or a new minted (p) is going to be troublesome and an unsuccessful endeavor, because now the issuer, the fingerprint (p) and the pNFT are all different. Also replacing the original physical item with the most superb untold copycat won't also work, even if this altered and fake physical item copycat have the same “itched” (p) the perfectly and artificially onboard. The counterfeiter still needs to hijack the blockchain transaction, which is next to impossible, to claim the real value and price of this “high net worth” pNFT and can't just get away with faking the said physical item.

This claim explores why pNFTs strip counterfeiters from the incentive to steal, simply put the asset value is far-fetched from the reach of their hands if even they can get their hands on the actual asset! Therefore, pNFTs in the latter context could very well guarantee physical items' authenticity provided that the issuer is a trusted party, see Claim [2] in sub claim (b).

Withholding the latter, a devised method is depicted using secret locations and reading sequence described for the said physical item Ornament area that only the buyer gets to know to counteract a stolen physical item pNFT, making pNFTs highly secure and impregnable to forgery. Specifically, this claim entitles:
(a) Security means depicted as in FIG. (15) describes a 3×3 secret PIN code using a stencil as a guide, by moving over with a mining rig like the pen-like standalone reading device described in Claim [4] sub-claim (6), a user can hover around a 5 PIN code sequence to unlock and verify the fingerprint of a recent pNFT purchase; for example, a mining sequence could be (4, 4, 3, 3, 4, 2) which operates like an unlocking dial pad on a smart phone screen. Such dial code could be updated by a seller and inform a buyer for security unlocking information sent out to the buyer phone as an sms or to a buyer email account with the new code details upon receipt of physical item.
(b) Furthermore, for increased security; by utilizing Augmented reality, a virtually superimposed projection grid on said physical item shown on a smart phone screen and utilizing a smart phone camera can virtually show and guide the user to a secret location on where to position the said stencil for the right placement and start reading the fingerprints in the right code place and sequence. Therefore, even though the stencil dimensions are known; the PIN code is not and its placement locations is unknown to anyone else, making it nearly impossible to hack. These two priori pieces of information are available to the buyer and are supplied via the NFT token purchased online away from the hands of intruders and counterfeiters. Stencils can come in different shapes, they can be thin strips or in a circular ring, a dial pad or any other form that is suitable to the physical item shape and dimensions.

8. Claim 8—(Embedding PUF Fingerprints in Place of IPFS CIDs)

As described in previous claims, specifically Claim [4], fingerprint generation turns to be more useful that just onchain physical identity ownership identifiers' storage i.e.: the p in the pNFT that could be residing on the blockchain. This claim modifies an existing offchain and legacy system by actually having the fingerprint p or hash serving as the replacement to IPFS pointers known as CIDs, the benefits of such arrangement or method is that it allows the Searchability Claim [6] function and encodes the same artwork or physical item metadata and link it to the actual fingerprint not some intermediary hash of some sort as in today's CIDs. Specifically, this claim entitles:
(a) Identification means depicted as in FIG. (20) whereby a hash generated from said microscopic Ornament or digital artwork being processed with said processes exhibited in Claim[4], said fingerprints can be used as a string of digits, characters and special characters to act both as a pointer to a location in a p2p network such as the IPFS, and most importantly encapsulating the essence of the artwork fingerprint or metadata minted in correspondence to its NFT, as such only from the address of the IPFS as shown in FIG. (20) now containing the fingerprint p hash instead; a physical item fingerprint can becomes verifiable directly from IPFS URI or “URL” equivalent without resorting to the NFT token itself, which was before the only means to tell the authenticity of a physical item's ownership certificate (NFT) as an IPFS network was the sole holder of the artwork metadata that an NFT points to. Having CIDs replaced by (p) hashes have benefits indicated in Claim[4] (b) as CID use very susceptible cryptographic hashing not suitable for physical item fingerprint generation.

9. Claim 9—(Making Physical Assets Intrinsically Limited Edition Items)

By applying Claim [5] sub claim (1), a new category of goods emerges with the standard magnification utility becoming part of products and physical items exterior design, just like Barcodes are all over today's products serving important regulatory and product encoded information like product origins, class, type, etc. This claim describes a new category of goods labeling specifically designed to make all product and physical items readily and globally NFT-able by using this application's new invention of pNFTs. At some point product designers start to embed these lenses as part of their products and not as an add-on. Specifically, this claim entitles:
(a) Labelling means: whereby physical items have built-in magnifying utilities as in Claim [4] sub claim (4). These magnifying utilities having microscopic lens that functionally or aesthetically integrated with said physical items. Also a new special type of lens in said magnifying utilities called Metalens could be deployed. Metalenses are a credit card thin type of lenses that work as microscopic lens and could be deployed as thin tags carried onto said physical items surfaces indicating products that come with an NFT certificate. All types of embodied lenses can withstand shock and scratches and can be covered with some protection sleeves that can be dismounted during which said physical items are minted. FIG. (24) and FIG. (25) show an application of this Claim on a set of luxury product's and on some physical toy products with the intent of releasing those as limited editions via pNFT tokens.

What is claimed is:

1. A computer implemented method for verifying the ownership of an article comprising:
applying one or more physically unclonable functions to an article;
associating the physically unclonable functions to a non-fungible token to create a digital fingerprint; and
storing the digital fingerprint on a blockchain network.

2. A computer system for verifying the ownership of an article comprising:
a computer processor operative to:
apply one or more physically unclonable functions to an article;
associate the physically unclonable functions to a non-fungible token to create a digital fingerprint; and
store the digital fingerprint on a blockchain network.

3. A non-transitory computer-readable storage medium for verifying the ownership of an article comprising instructions which, when executed, cause a computing device to:
apply one or more physically unclonable functions to an article;
associate the physically unclonable functions to a non-fungible token to create a digital fingerprint; and
store the digital fingerprint on a blockchain network.
